(19) United States
(12) Patent Application Publication
(10) Pub. No.: US 2003/0016407 A1
(43) Pub. Date: Jan. 23, 2003

(54) Data communications apparatus with memory transfer function

(75) Inventor: Kazuhiro Satoh, Kanagawa (JP)

Correspondence Address: RICHARD F. JAWORSKI, Cooper & Dunham LLP, 1185 Avenue of the Americas, New York, NY, 10036, US

(73) Assignee: Ricoh Company, Ltd.,

(21) Appl. No.: 10/175,244

(22) Filed: Jun. 19, 2002

(30) Foreign Application Priority Data
Jun. 21, 2001 (JP) PATENT2001-188443

(51) Int. Cl. H04N 1/00; H04N 1/46

(52) U.S. Cl. 358/524; 358/402

(57) ABSTRACT

A data communications apparatus comprises a memory and a system controller including a data transfer unit and a determination unit. The data transfer unit receives data from a source terminal, stores the received data in the memory, and transfers the stored data to a destination terminal. The determination unit determines whether data transfer to the destination terminal has been successfully carried out. The data transfer unit further tries to retransmit the data up to a predetermined number of times if the data transfer has been unsuccessful. The memory retains the data for a predetermined period of time if the predetermined number of retransmissions was unsuccessful.

### BACKGROUND OF THE INVENTION

1. Field of the Invention

The present invention relates to a data communications apparatus, such as facsimile machines or Internet facsimile machines, having a memory transfer function for transferring data from a source (or a transmission terminal) to one or more destinations (or receiving terminals).

2. Description of Related Art

Recently proposed data communications apparatuses (such as Internet facsimile machines) are furnished with support for connection to a local area network (LAN). Accordingly, many attempts have been made to construct a network system using data communications apparatuses making use of connection to LANs.

One example of such LAN-supported network systems is a memory transfer system disclosed in Japanese Patent Laid-Open Publication Nos. 8-289113 and 10-271310. The memory transfer system receives data containing either images or text and transfers the data to destination(s). FIG. 1 illustrates a conventional network system including data communications apparatus 900. The data communications apparatus 900 receives data, including a facsimile document or an e-mail text and picture, from the source 910 and stores the received data in memory 901. Then, the data communications apparatus 900 transfers the data from memory 901 to one or more destinations 920.

The source 910 includes a group 3 facsimile apparatus (G3-FAX) 911, a group 4 facsimile apparatus (G4-FAX) 912, and an e-mail terminal (e.g. a personal computer) capable of transmitting electronic mail. The destination 920 includes a group 3 facsimile apparatus (G3-FAX) 921, a group 4 facsimile apparatus (G4-FAX) 922, and a server 923. The server 923 provides services to client terminals, such as personal computers 930, and delivers e-mails received from the data communications apparatus 900 to the addressed personal computer 930. If the communication modes of the source (or the transmission terminal) 910 and the destination (or the receiving terminal) 920 differ from each other, for example, between a facsimile machine and a cellular phone with e-mail function, then the data communications apparatus 900 converts the data retrieved from the memory 901 to an appropriate form in agreement with the communication mode of the destination 920.

There are three methods known in the art for allowing the data communications apparatus 900 to identify the destination(s) 920 to which the data should be transferred. The first method is that the data communications apparatus 900 identifies the destination 920 based on the facsimile number or the e-mail address of the destination terminal directly input by the caller through the transmission terminal 910.

The second method is that the data communications apparatus 900 assigns in advance an F code or a sub-address to each destination terminal 920 and stores the F code or the sub-address of each terminal in the memory 901. When the data communications apparatus 900 receives data from a source terminal 910; it detects the F code or the sub-address input by the caller (i.e., the user of the source terminal 910)., and refers to the memory 901 to determine the destination(s) 920 based on the F code or the sub-address.

The third method is that the data communications apparatus 900 registers destination terminals in advance in association with each source terminal, and stores the corresponding relations between each source and the designated destinations in the memory 901. When receiving data from a source terminal 910, the data communications apparatus 900 identifies the source terminal 910 based on the caller information or the e-mail address of the source terminal 910, and then refers to the memory 901 to specify the destination terminal(s) 920 based on the corresponding relation.

By constructing a memory transfer system using the LAN-supported data communications apparatus 900, communication cost is reduced, while greatly reducing the caller's time for dialing several places to send the same message. In particular, connecting the data communications apparatus 900 via LAN to the e-mail terminal 913 or the server 923 realizes paperless facsimile.

However, the conventional data communications apparatus 900 has a drawback in its operability especially when it fails to transfer data to the destination for some reason. In failing data transfer, the conventional data communications apparatus 900 attempts to transfer data repeatedly at a certain time interval for a limited number of times. If the data transfer cannot be completed even after the maximum number of attempts, the data communications apparatus 900 outputs a hard copy report reporting the failure of the transmission, together with a hard printed copy of the data that has not been transmitted. Then, the data communications apparatus 900 deletes the data from the memory 901.

In order to deliver the deleted data to the destination 920, the user or the system manager of the data communications apparatus 900 has to check the transmission report to identify the destination 920 that failed to receive the data. The system manager also has to have the hard copy print scanned using a scanner (not shown) to produce image data, which is then transferred from the data communications apparatus 900 to the destination terminal 920. Alternatively, the system manager has to ask the user of the source terminal 910 to resend the same message to the destination 920.

In this manner, the conventional data communications apparatus 900 is inconvenient in its operability because of the above-described troublesome process accompanying the failure of data transmission.

In addition, the server 923 is likely to have a longer down time due to planned maintenance, memory backup, and other factors, as compared with a G3-FAX 921 or G4-FAX 922. Therefore, the amount of hard copies of transmission-error reports, as well as the printed copies of untransferred data, naturally increases. In such a situation, great volume of copies and papers are produced in spite of the initial aim to realize paperless facsimile making use of the LAN-supported data communications apparatus 900.

### SUMMARY OF THE INVENTION

Therefore, it is an objective of the invention to provide a data communications apparatus having an improved memory transfer function with enhanced operability especially when data transmission to the destination terminal is unsuccessful.

To achieve the objective, a data communications apparatus comprises a memory; a data transfer unit configured to receive data from a source terminal, store the received data in the memory, and transfer the stored data to a destination terminal; and a determination unit configured to determine whether data transfer to the destination terminal has been successfully carried out. The memory retains the data for a predetermined retention time if the data transfer has been unsuccessful.

The data transfer unit further tries to retransmit the data up to a predetermined number of times if the data transfer has been unsuccessful, and the memory retains the data for the predetermined retention time if the predetermined number of retransmissions is unsuccessful.

In this manner, the data communications apparatus still retains data (e.g., pixel data) in its memory without deleting if the data have not been successfully transferred to the destination terminal even after the predetermined number of retransmissions. The data retained in the memory can be used for further session of transferring to the destination terminal. Consequently, the user of the data communication apparatus does not have to check the hard copy print of transmission reports or scan the print-out data before retransmitting the pixel data. Thus, the operability of the data communications apparatus is improved.

The data retained in the memory may be automatically deleted after the retention time has passed. This arrangement can prevent the memory from overflowing due to the accumulation of data that has not been transferred.

The data transfer unit may automatically set up the retention time when the predetermined number of retransmissions is unsuccessful. Alternatively, the data communications apparatus further comprises an operation panel that allows a user to set the retention time. The latter arrangement can allows the user to select a suitable retention time, and therefore, the operability of the data communications apparatus is further improved.

Preferably, the data communications apparatus further comprises a display that displays information about the data retained in the memory and an operation panel that allows a user to input a data deletion command based on the information on the display. The data retained in the memory is deleted in response to the data deletion command.

With this arrangement, the user can determine whether the data should be deleted depending on the situation, contents of the data, and other factors before the data is automatically deleted from the memory. Consequently, the data transfer is conducted more flexibly with improved operability.

Preferably, the data transfer unit further retransmits the data at least once within the retention time if the predetermined number of retransmissions is unsuccessful. This arrangement guarantees more reliable data transfer, efficiently using the data retained in the memory. The likelihood of successful data transfer increases because data transfer is again tried even after the predetermined number of retransmissions is unsuccessful.

The data communications may further comprises a display that displays information about the data retained in the memory and an operation panel that allows a user to input a retransmission command based on the information on the display. The data transfer unit further retransmits the data in response to the retransmission command.

This arrangement makes the data communications apparatus more flexible and reliable because the user can try to retransmit the data even after a predetermined number of retransmissions is conducted unsuccessfully.

Alternatively, the data communication apparatus may further comprises a display that displays information about the data retained in the memory and an operation panel that allows a user to change the destination terminal to another destination. The data transfer unit retransmits the data to the newly selected destination.

This arrangement also realizes a data communications apparatus with an improved flexibility and reliability because the user can change the destination or select a new destination if the data transfer is unsuccessful.

The data communication apparatus may further comprise a printing unit, a display that displays information about the data retained in the memory, and an operation panel that allows a user to input a print command based on the information on the display. The printing unit prints out the data in response to the print command.

This arrangement allows the user to examine the contents of the pixel data before the data are automatically deleted from the memory. Consequently, the user can appropriately determine whether to retransmit or delete the data during the data retention time.

The data determination unit may determine whether or not the data is to be retained in the memory based on a type and a communication mode of the destination. For example, the memory retains the data if the destination terminal has an electronic mailing function.

### BRIEF DESCRIPTION OF THE DRAWINGS

Other features and advantages of the invention will become apparent from the following detailed description in conjunction with the attached drawings, in which:

FIG. 1 illustrates an example of a data transfer system using conventional data communications apparatus;

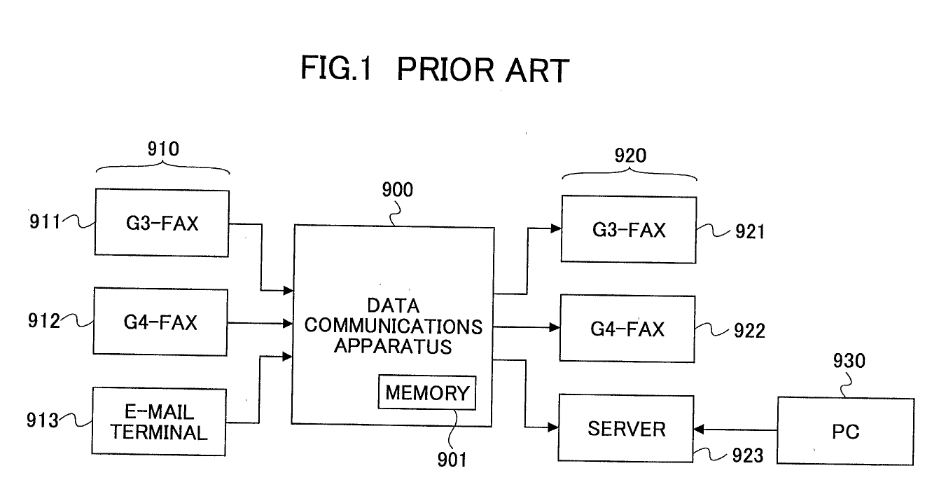

FIG. 2 is a block diagram of the data communications apparatus according to an embodiment of the invention;

FIG. 3 is a flowchart of registration of destination terminals in correspondence with source terminals employed in the data communications apparatus shown in FIG. 2;

FIG. 4 is a flowchart of the first part of the operations performed by the data communications apparatus when a call is received at the data communications apparatus according to the first embodiment of the invention;

FIG. 5 is a flowchart of the second part of the operations performed by the data communications apparatus, which continues from the operation flow shown in FIG. 4;

FIG. 6 illustrates a modification of the operation flow of the second part shown in FIG. 5;

FIG. 7 is a flowchart of deleting pixel data from the memory of the data communications apparatus according to the second embodiment of the invention;

FIG. 8 is a flowchart of deleting pixel data from the memory of the data communications apparatus according to the third embodiment of the invention;

FIG. 9 is a flowchart of retransmitting pixel data retained in the memory to the destination according to the fourth embodiment of the invention;

FIG. 10 is a flowchart of retransmitting pixel data retained in the memory to the destination according to the fifth embodiment of the invention;

FIG. 11 is a flowchart of changing the destination to which the pixel data are to be transferred according to the sixth embodiment of the invention;

FIG. 12 is a flowchart of printing out untransferred pixel data according to the seventh embodiment of the invention;

FIG. 13 is a flowchart of the first part of the operations performed by the data communications apparatus when a call is received at the data communications apparatus according to the eighth embodiment of the invention; and

FIG. 14 is a flow flowchart of the second part of the operations performed by the data communications apparatus, which continues from the operation flow shown in FIG. 13.

### PREFERRED EMBODIMENT

Preferred embodiments of the invention will now be described in more detail.

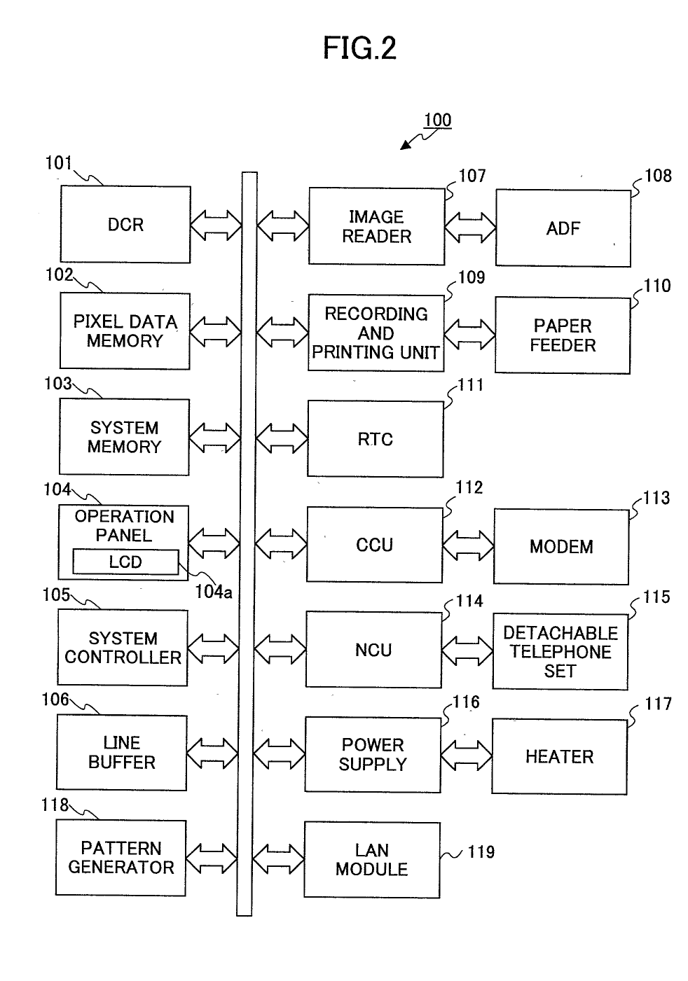

FIG. 2 illustrates an example of a data communications apparatus 100 according to an embodiment of the invention. The data communications apparatus 100 includes DCR (data compression and reconstruction) unit 101 that compresses and reconstructs pixel data, memory 102 storing pixel data, a system memory 103 storing communication management information and system administration data associated with the pixel data, an operation panel 104 having an LCD 104a, and a system controller 105 controlling the entire operation of the system. The system 100 also includes a line buffer 106 used when actually transmitting data to the destination, an image reader or a scanner 107, an ADF (automatic document feeder) 108, a recording and printing unit 109 that records and prints the scanned image onto paper, and a paper feeder 110 supplying paper to the recording and printing unit 109.

The data communications apparatus 100 further includes an RTC (real time clock) 111 with a timer function, a CCU (communication control unit) 112, a MODEM 113 for modulating and demodulating signals and detecting and outputting images at various tones, an NCU (network control unit) 114, and detachable telephone set 115. The data communications apparatus 100 further includes an AC power supply 116 that outputs +5V, +24V, −12V signals from a 100V AC voltage source, a heater 117 that is turned on and off in response to heater control signals supplied from the power supply 116, a pattern generator converting characteristic codes into bit patterns, and LAN module 119 that allows the system to be connected to a LAN.

The data communications apparatus 100 illustrated in FIG. 2 constitutes as memory transfer system, functioning as a data transfer management unit in addition to its ordinary data communication ability (e.g., as a facsimile machine or an e-mail terminal). When functioning as a data transfer management unit, the data communications apparatus 100 receives pixel data transmitted from a source terminal, stores the pixel data in the pixel data memory 102, and transfers the pixel data read out of the pixel data memory 102 to designated destination terminal(s). This series of data transfer operations is carried out by a data transfer unit (not shown) residing in the system controller 105. The system controller 105 also has a determination unit (not shown) that determines whether or not pixel data read out of the pixel data memory 102 have been successfully transferred to the destination. If the data transfer to the destination has not been completed, the system controller 105 causes the pixel data memory 102 to retain the pixel data until the data are successfully transferred to the destination or until a user command for deleting the data from the pixel data memory 102 is generated.

The system 100 may user any suitable techniques for identifying the destination to which the pixel data stored in the pixel data memory 102 are to be transferred. In this embodiment, the system 100 employs the third method described in conjunction with the prior art. That is, destination terminals are registered in the system 100 in advance so as to correspond to associated source terminals. If receiving pixel data from a source terminal, the system 100 identifies this source terminal from the source information (including terminal ID or the e-mail address) of the source terminal. Then, the system 100 retrieves in the system memory 103 the corresponding relation between this source terminal and designated destination(s) in order to identify the destination terminal(s) to which the data should be forwarded.

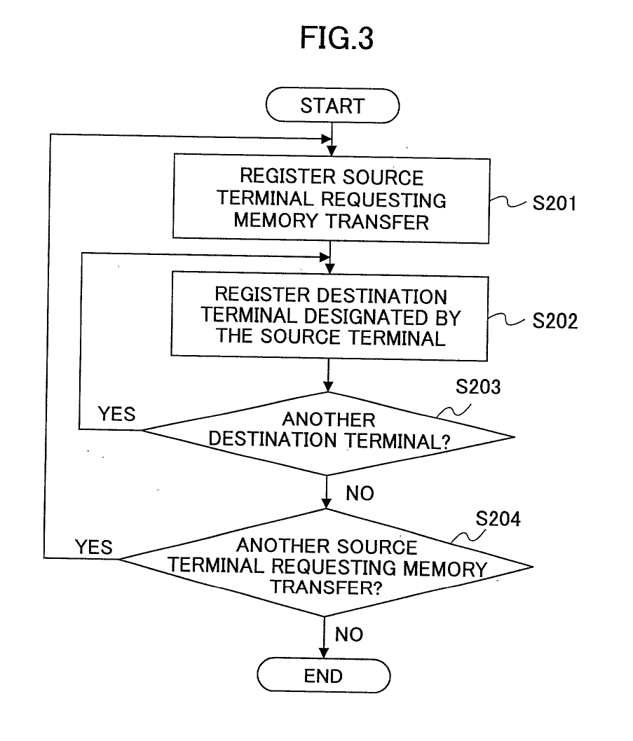

FIG. 3 shows the operation flow of registration of source and destination terminals. First, in S201, a source terminal that makes use of the memory transfer function of the data communications apparatus 100 is registered. For the entry of the source terminal, source information, such as the terminal ID or the e-mail number of the source terminal, is input to the system memory 103 through the operation panel 104. Then, in S202, a destination terminal designated in advance by the user of the source terminal is entered in the system memory 103 in association with the source terminal. In S203, it is determined whether there is another destination terminal designated by the user of this source terminal. If there is any other destination terminal designated by this source terminal (YES in S203), the process returns to S202 to repeat steps S202 and S203. If there is not another destination terminal designated by the source terminal (NO in S203), the process proceeds to S204, in which it is determined whether there is another source terminal to be registered in the data communications apparatus 100. If there is another source terminal (YES in S204), the process returns to S201 to repeat the foregoing steps. If there is not another source terminal to be registered (NO in S204), the process terminates.

In this manner, destinations are registered in advance in association with corresponding source terminals. For example, if source information indicates the source ID# ABCD, then the data are automatically transferred to the registered destinations of facsimile #03-XXXX-XXXX and e-mail address ΔΔΔΔ@ricoh.co.jp. Similarly, if the source information indicates the e-mail address XXX@ricoh.co.jp of source terminal, then the data are automatically transferred to facsimile #045-yyy-zzzz. One or more destinations can be registered for each source terminal.

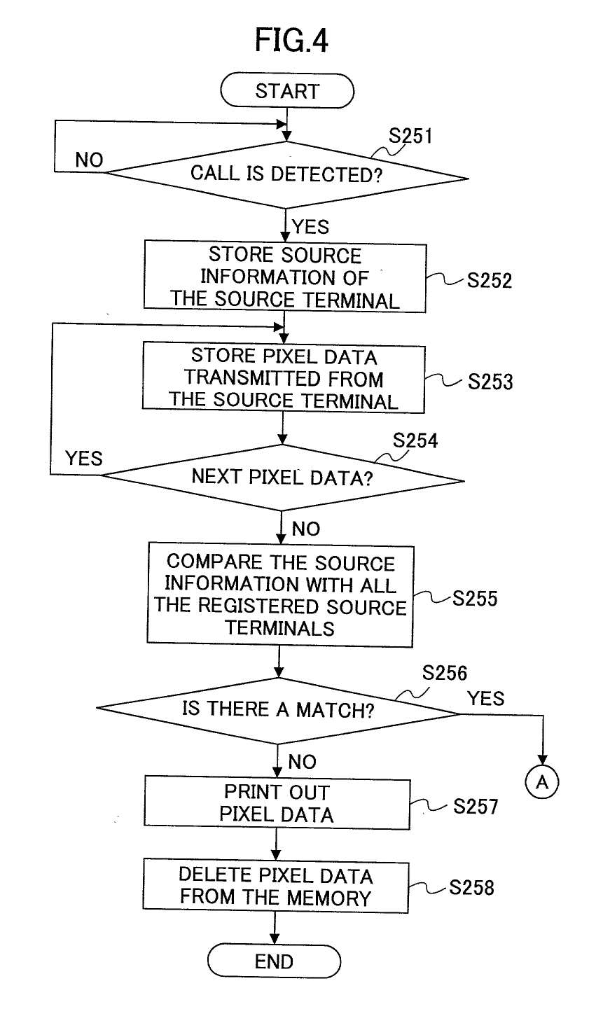

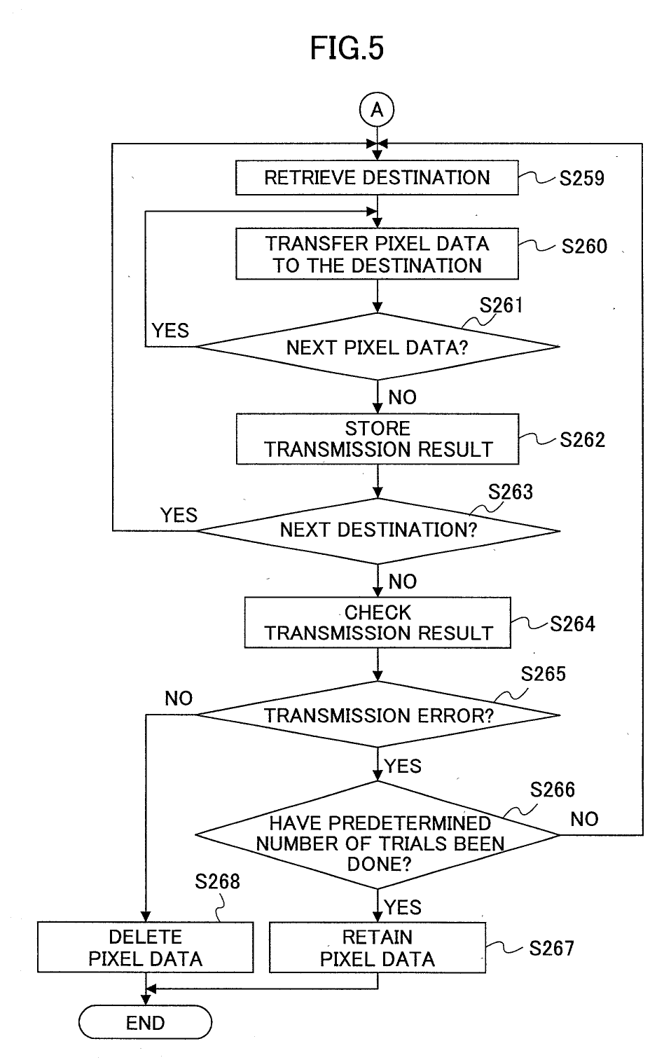

FIG. 4 and FIG. 5 illustrate an operation flow of the data communications apparatus 100 to retain data in the pixel data memory 102 when the data are not successfully transferred to the destination according to the first embodiment of the invention. The process shown in FIG. 5 continues from point A shown in FIG. 4.

First, in step S251, the system controller 105 determines if there is a call received by the data communications apparatus 100. A call is detected, for example, by CCU 112 or LAN module 119. If there is a call (YES in S251), source information (such as a terminal ID or the e-mail address) about the received call is extracted and stored in the system memory 103 in step S252. Subsequently, the entirety of pixel data received by the data communications apparatus 100 in conjunction with the call is stored in the pixel data memory 102 in steps S253 and S254.

If all of the whole pixel data have been stored (NO in S254), the system controller 105 compares the source information of this call (that was stored in the system memory 103 in S252) with the list of the registered source terminals in S255. Then, it is determined in S256 whether there is a match between the detected source information and the listed source terminals. If there is no match in the system memory 103 (NO in S256), that is, if the source terminal of the current call is not registered in the system memory 103, then it is determined that the current call is a regular facsimile transmission addressed to the data communications apparatus 100, irrelevant to memory transfer operation. In this case, the pixel data are printed out (output) on paper supplied from paper feeder 110 in S257. Then the pixel data are deleted from the pixel data memory 102 in S258.

If in S256 there is a match in the system memory 103 (YES in S256), the process proceeds to S259 shown in FIG. 5, and one of the destination terminals, which are registered in advance in association with the current source terminal, is retrieved in the system memory 103. Then, in step S260, the pixel data relating to this call are read from the pixel data memory 102 and transferred to the retrieved destination. If the destination is a facsimile terminal, the pixel data are transmitted from the MODEM 113 of the CCU 112 via, for example, a public network. If the destination is an e-mail terminal, the pixel data are transferred to the server under the control of LAN module 119.

When the pixel data are completely transmitted to the destination, the system controller 105 causes the CCU 112 or the LAN module 119 to produce a transmission result, and stores the transmission result in the system memory 103 (in step S262). Then, it is determined in S263 whether there is another destination to which the pixel data are to be transferred. If YES in S263, the process returns to S259 to repeat steps S259 through S262.

When the transferring of the pixel data to all of the designated destinations has been carried out (NO in S263), the system controller 105 checks all the transmission results (in S264), and determines in S265 whether there is a transmission error the in data transfer to a specific destination.

If there is a transmission error found in the transmission result (YES in S265), the system controller 105 determines in S266 whether retransmission of the pixel data to this specific destination has already been repeated a predetermined number of times (five times, for example). If the number of times of retransmission has not reached the predetermined number (NO in S266), the process returns to S259, and the routine from S259 through S265 is repeated at a predetermined time interval (for example, every five minutes) until transmission of the pixel data to the destination is successfully completed. On the other hand, if retransmission has already be repeated the predetermined number of times (YES in S266), the system controller 105 determines that the attempt of transferring the pixel data to this destination is unsuccessful, and generates a data retention command. Consequently, the pixel data are retained in the pixel data memory 102 in S267.

If in S265 there is no transmission error found in the transmission result, it is determined that memory transfer is successfully completed. In this case, the process jumps to S268, and the pixel data are deleted from the pixel data memory 102. At the same time, the source information in association with the current call is deleted from the system memory 103.

In order to transfer this pixel data to the specific destination later on in this routine, the pixel data are simply read from the pixel data memory 102 without requiring the user to scan the print-out copy. Accordingly, the data communications apparatus 100 becomes much more practical, as compared with the conventional data communications apparatus.

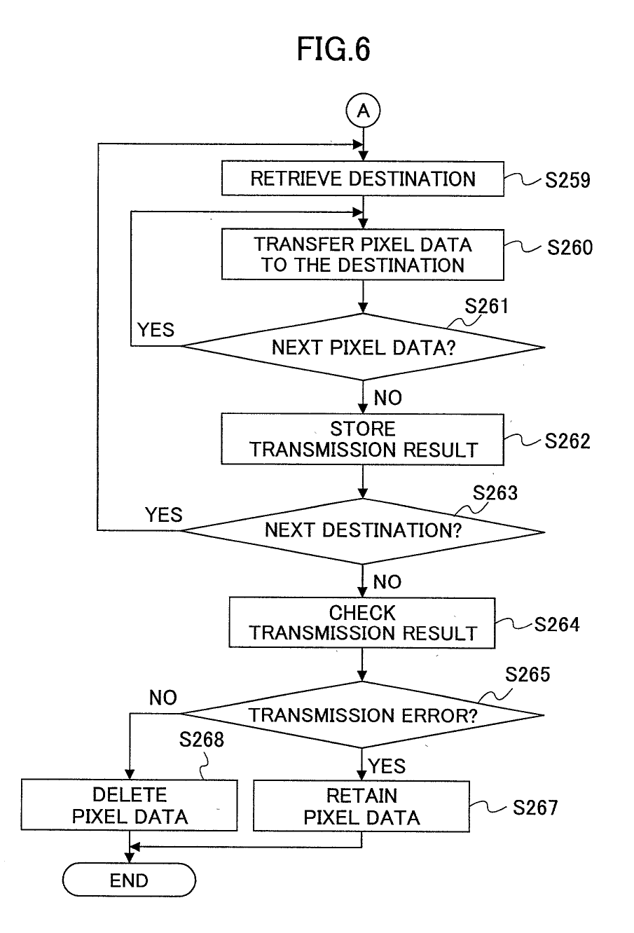

The operation flow shown in FIG. 5 (that is, the latter part of the data transfer operation) may be modified as shown in FIG. 6. In FIG. 6, attempt of retransmission to the unsuccessful destination a predetermined number of times (S266 in FIG. 5) is omitted. Even if this step is omitted, the pixel data are retained in the pixel data memory 102 for later transmission if there is a transmission error to a specific destination.

<Second Embodiment>

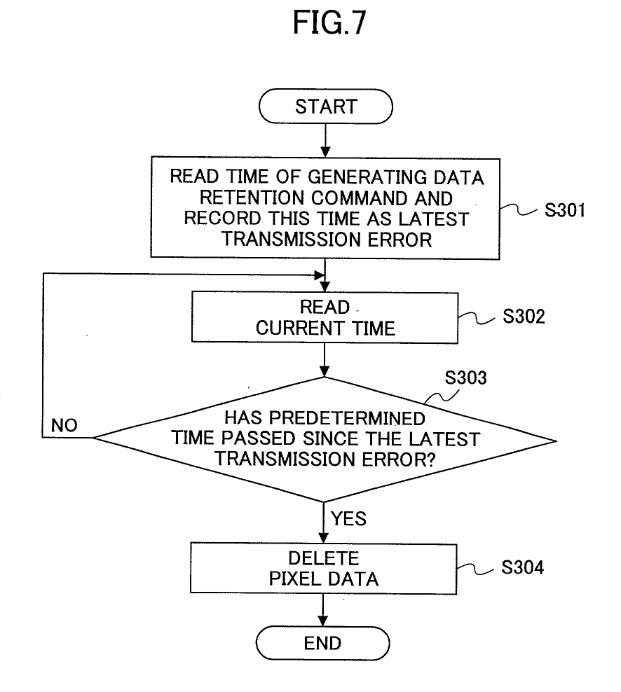

FIG. 7 illustrates an operation flow of the data communications apparatus 100 according to the second embodiment of the invention, which focuses on deleting pixel data from the pixel data memory 102 under a certain circumstance.

The operation flow shown in FIG. 7 is carried out when unsuccessful data transmission is detected and the pixel data are retained in the pixel data memory 102. In the second embodiment, the data communications apparatus 100 allows the user to set up the data retention time for the untransferred pixel data through the operation panel 104. The data retention time selected by the user is stored in the system memory 103. The retention time may be a time period, such as ten minutes, three hours, two days, etc, or alternatively, the user may select the end time of data retention (for example, until 6 o'clock in the evening). The pixel data are retained in the pixel data memory 102 for the selected retention time or until the selected time as long as the pixel data have not been successfully transferred to the destination, even after a predetermined number of retransmissions are tried.

In operation, the system controller 105 starts the process following step S267 shown in FIG. 5 or 6. First, in S301, the system controller 105 reads the latest time at which the data retention command is generated (that is, the data communications apparatus 100 failed to transfer the pixel data to the destination). The system controller 105 records the time of generation of the data retention command as the latest unsuccessful transmission time in the system memory 103.

Then, in step S302, the system controller 105 reads the current time from the RTC 111 at a predetermined interval, and determines in step S303 whether a predetermined retention time has passed since the latest transmission error. For example, the system controller 105 monitors whether the following relation is satisfied to carry out the determination of step S303.

(Time of the latest transmission error)+(retention time)<(current time)

If the predetermined retention time has passed since the latest transmission error (YES in S303), the system controller 105 deletes the pixel data in S304, as well as deleting the source information, destination information, the transmission result, etc. from the system memory 103. Unless the predetermined retention time has passed (NO in S303), the pixel data are retained in the pixel data memory 103.

If the user selects the end time of data retention, the system controller 105 simply compares the current time read from the RTC 111 with the end time selected by the user.

In the second embodiment, the untransferred pixel data are automatically deleted from the pixel data memory 102 if a certain condition is satisfied after the pixel data have been retained in the memory 102 for a predetermined period of time. Consequently, overflow of the pixel data memory 102 due to accumulated untransferred pixel data is prevented.

The data retention time may be automatically set in the data communications apparatus 100, instead of allowing the user to manually set the retention time. If the user wishes to set up new data retention time, the user can reset the automatically selected retention time through the operation panel 104 or change the previously selected data retention time. In this case, brief data about the respective untransferred pixel data may be displayed on the LCD panel 104a in order to allow the user to select suitable retention time independently for the respective pixel data. Alternatively, a single retention time may be selected in common for all kinds of untransferred information.

By automatically removing pixel data that have been stored in the pixel data memory 102 for a predetermined retention time, the system does not have to frequently monitor the total amount of untransferred pixel data accumulated in the pixel data memory 102.

<Third Embodiment>

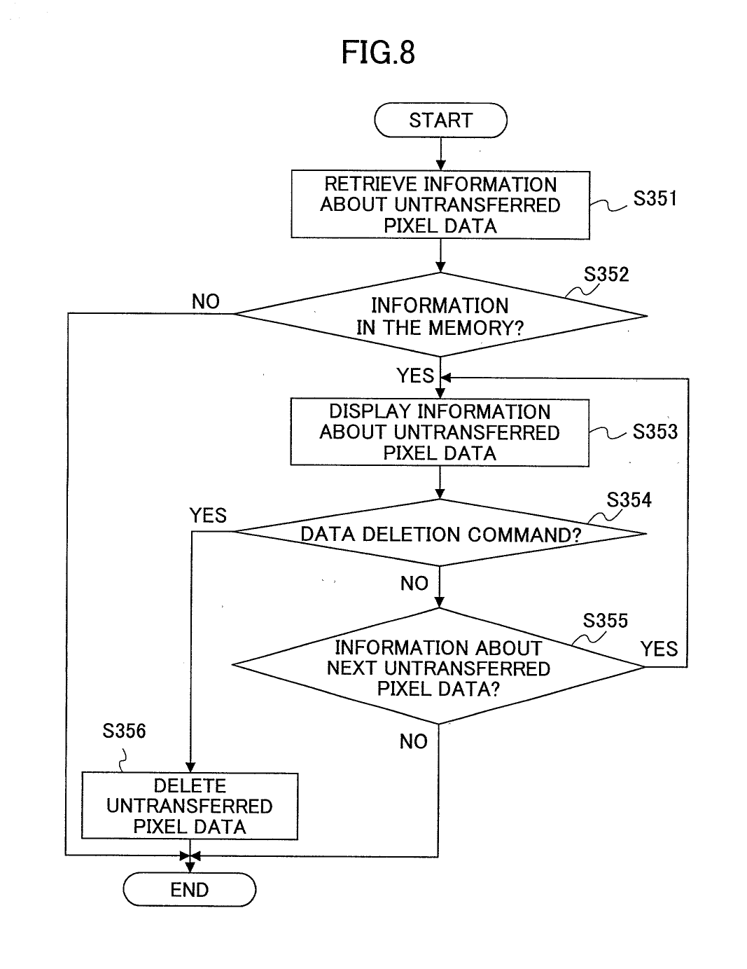

FIG. 8 illustrates an operation flow of deleting pixel data from the pixel data memory 102 according to the third embodiment of the invention. In the third embodiment, the data communications apparatus 100 allows the user to determine whether the untransferred pixel data should be further retained in or deleted from the pixel data memory 102.

In operation, the user can have necessary information about untransferred pixel data displayed on the LCD panel 104a through manipulation on the operation panel 104. Upon receiving the user's manipulation, the system controller 105 retrieves from the system memory 103 necessary information requested by the user in association with untransferred pixel data still retained in the pixel data memory 102 (in step S351). The system controller 105 determines whether the requested data exist in the system memory 103 (in step S352).

If there is no information in the system memory 103 associated with untransferred pixel data (NO in S352), the process terminates. On the other hand, if there is relevant information (YES in S352), then the system controller 105 causes the information to be displayed on the LCD panel 104a (in step S353).

Based on the displayed information, the user can determine whether to delete the untransferred pixel data from the pixel data memory 102. If the user wishes to delete this pixel data, the user can input a delete command through the operation panel 104. The system controller 105 determines whether a delete command has been input by the user (in step S354). If there is no delete command input detected (NO in S354), the system controller 105 further determines whether there is other information about untransferred pixel data in the system memory 103 (in step S355).

If there is no other information in the system memory 103 about untransferred pixel data (NO in S355), the process terminates. If there is other information (YES in S355), then the process returns to step S353 to repeat the steps S353 through S355.

If, in step S354, a delete command input by the user has been detected, the system controller 105 causes the pixel data in connection with the information retrieved and displayed on the LCD panel 104a to be deleted from the pixel data memory 102 (in step S356). At the same time, the information displayed on the LCD panel 104a is also deleted from the system memory 103.

The user can delete multiple sets of untransferred pixel data from the pixel data memory 102 by repeating the process illustrated in FIG. 8.

Thus, in the third embodiment, untransferred pixel data retained in the pixel data memory 102 can be deleted based on the data delete command input by the user at a suitable timing. Consequently, overflow of the pixel data memory 102 can be prevented.

In addition, as compared with the second embodiment, the arrangement of the third embodiment has an advantage that unnecessary pixel data can be deleted from the pixel data memory 102 when, for example, the user knows that the pixel data have been transmitted from the source terminal directly to the destination without passing through the data communications apparatus 100.

Instead of, or in addition to, displaying information stored in the system memory 103 in association with pixel data, a portion or all of the untransferred pixel data itself may be displayed on the LCD panel 104a.

Deleting untransferred pixel data at a request by the user is preferable if the data communications apparatus 100 has a display (such as an LCD) on which necessary information is displayed. On the other hand, if the data communications apparatus 100 does not have a display, then automatic deletion of untransferred pixel data as described in the second embodiment is preferably employed.

<Fourth Embodiment>

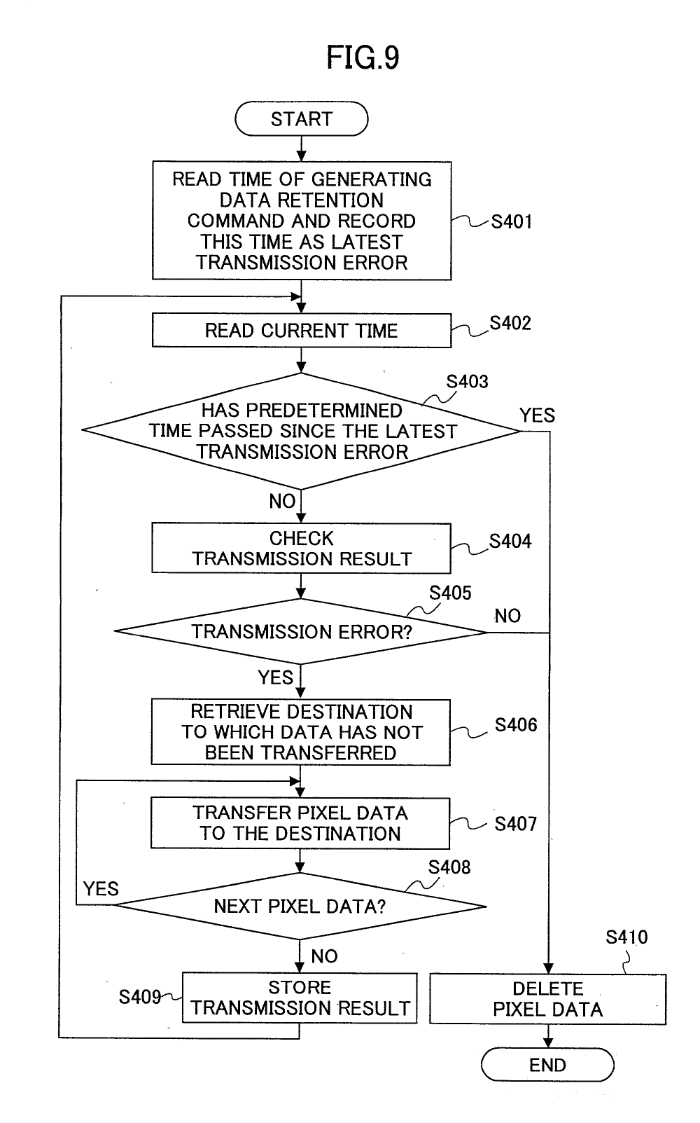

FIG. 9 illustrates an operation flow of the data communications apparatus 100 to retransmit the untransferred pixel data after repetition of a predetermined number of initial attempts according to the fourth embodiment of the invention. The process illustrated in FIG. 9 is carried out after step S267 shown in FIG. 5 has been done.

In the fourth embodiment, transmission result is checked repeatedly within the predetermined retention time in order to make a further attempt to transfer the pixel data to the destination even after a predetermined number of initial attempts are finished. A retention time is set up in-advance in order to allow the pixel data that have not been successfully transferred to remain in the pixel data memory 102 for further sessions.

In operation, if the pixel data are retained in the pixel data memory 102 in S267 as shown in FIG. 5, then the system controller 105 reads the latest time at which a data retention command is generated (that is, at which the data communications apparatus 100 failed to transfer the pixel data to the destination) in step S401. The system controller 105 records the time of generation of the data retention command as the latest unsuccessful transmission time in the system memory 103.

Then, in step S402, the system controller 105 reads the current time from the RTC 111 at a predetermined interval, and determines in step S403 whether a predetermined retention time has passed since the latest transmission error. For example, the system controller 105 monitors whether the following relation is satisfied to carry out the determination of step S403.

(Time of the latest transmission error)+(retention time)<(current time)

If the predetermined retention time has passed since the latest transmission error (YES in S403), the system controller 105 deletes the pixel data from the pixel data memory 102, and deletes associated information from the system memory 103 in step S410. Then, the process terminates. On the other hand, if the data retention time has not passed since the latest unsuccessful data transfer (NO in S403), the system controller 105 checks the transmission result stored in the system memory 103 for all the destinations designated by the current source terminal (in step S404).

In step S405, the system controller 105 determines whether or not there is a destination to which the pixel data have not been successfully transferred. If there is an unsuccessful destination (YES in step S405), the system controller 105 retrieves the unsuccessful destination from the system memory 103 (in step S406). Then, the system controller 105 reads all the pixel data with respect to the current call out of the pixel data memory 102, and transfers the pixel data to the retrieved destination (in steps S407 and S408).

If all the pixel data have been transferred to the destination (NO in S408), the system controller 105 causes the CCU 112 or the LAN module 119 to output the transmission result for the current data transfer, and records the transmission result in the system memory 103 (in step S409).

The system controller 105 repeats steps S402 through S409 at a predetermined cycle, except for when the data retention time has passed (YES in S403) or when there is no other unsuccessful destination (NO in S405). The time interval of repeating the steps S402 through S409 within the data retention time may be set longer than the time interval of the former trials of data transfer carried out in steps S259 through S266. For example, steps S402 through S409 may be repeated every ten minutes within the data retention time, while the steps S259 through S266 for the retransmission is repeated every five minutes. Or alternatively, the time intervals of repeating retransmission of the untransferred pixel data may be set equal before and after starting the data retention time.

If there is not another unsuccessful destination detected in the determination step S405, which is carried out in the second or the subsequent sessions of repetition, the system controller 105 deletes the pixel data and the associated information from the pixel data memory 102 and the system memory 103, respectively in step S410, and terminates this routine.

In the fourth embodiment, the number of destinations to which the pixel data is not successfully transferred can be reduced even after the regular memory transfer operation has been done.

Instead of repeating steps S402 through S409 within the data retention time, retransmitting the untransferred pixel data may be carried out only once. In addition, the time interval of the repetition of steps S402 through S409 does not have to be constant. For example, the interval may be prolonged gradually, for example, by trying to retransmit the pixel data at varying time intervals of 10 minutes, 20 minutes, 40 minutes, etc.

The user may have all or a portion of the untransferred pixel data retained in the pixel data memory 102 displayed on the LCD panel 104a to determine independently whether or not each set of untransferred pixel data should be transferred to the destination. In addition, based on the displayed information, the user may set an appropriate time interval of retransmission independently for each set of pixel data.

Alternatively, the time interval or other conditions may be set equal for all the untransferred pixel data sets if information about untransferred pixel data is not displayed on the data communications apparatus 100.

<Fifth Embodiment>

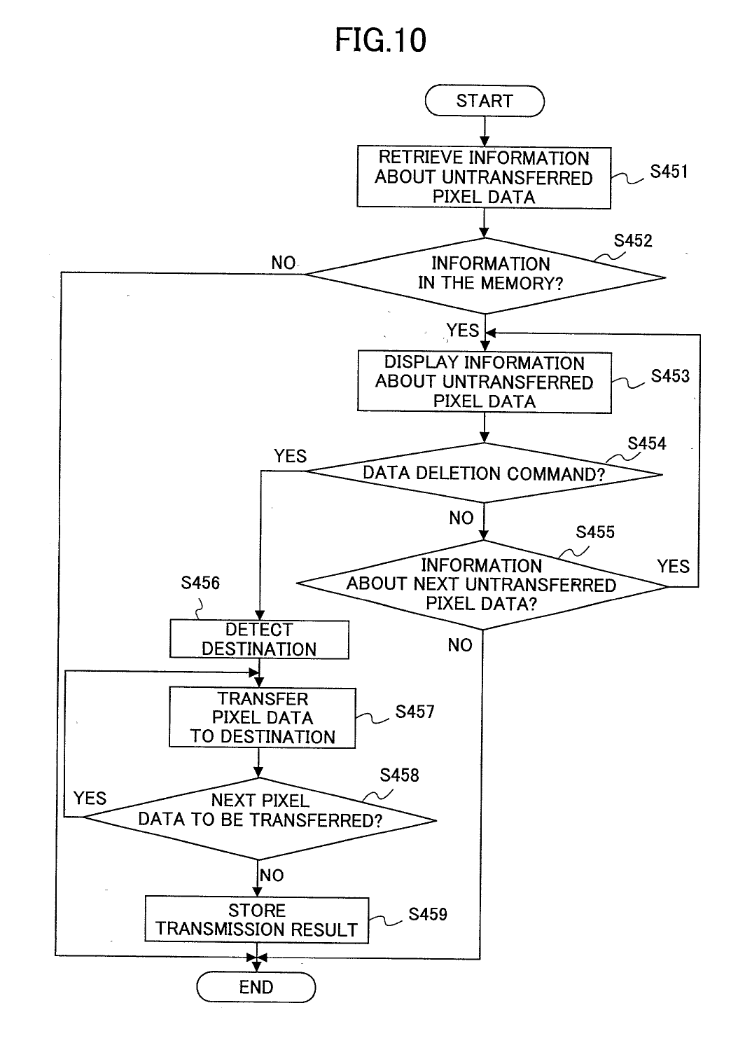

FIG. 10 illustrates an operation flow of the data communications apparatus 100 to allow the user to manually retransmit the untransferred pixel data through the operation panel 104 according to the fifth embodiment of the invention.

In operation, the user can have the information about the untransferred pixel data displayed on the LCD 104a through manipulation of the operation panel 104. Upon the user's manipulation, the system controller 105 retrieves from the system memory 103 information about untransferred pixel data (in step S451), and determines whether there is any information about untransferred pixel data stored in the system memory 103 (in step S452).

If there is no information about untransferred pixel data in the system memory 103 (NO in S452), the process terminates. If there is information (YES in S452), the system controller 105 causes the information about untransferred pixel data to be displayed on the LCD 104a (in step S453).

Based on the information displayed on the LCD 104a, the user can determine whether the untransferred pixel data corresponding to the displayed information should be retransmitted to the destination. If retransmission to the destination is required, the user can input a request for retransmitting the untransferred pixel data through the operation panel 104. The system controller 105 monitors the input signal and determines whether there is a request for retransmission input by the user (in step S454). If there is no request for retransmission detected (NO in S454), the system controller 105 further determines whether there is information about another set of untransferred pixel data (in step S455).

If there is no other information about untransferred pixel data (NO in S455), the process terminates. If there is other information (YES in S454), the process returns to step S453 to repeat steps S453 through S455.

If in step S454 there is a request for retransmission input by the user (YES in S454), the system controller 105 retrieves the destination terminal indicated by the information displayed on the LCD 104a (in step S456). Then, the system controller 105 reads the entirety of untransferred pixel data corresponding to the retransmission request out of the pixel data memory 102, and transfers this pixel data to the destination terminal (in steps S457 and S458).

If the requested pixel data are fully transferred (NO in S458), the system controller 105 causes the CCU 112 or the LAN module 119 to produce a transmission result, and stores the transmission result in the system memory 103 (in step S459).

In this manner, the data communications apparatus 100 of the fifth embodiment can retransmit untransferred pixel data to the destination based on the user's request for retransmission. Accordingly, the number of unsuccessful destinations that fail to receive the pixel data is reduced even after a predetermined number of automatic memory transfers have been tried.

Although the information about untransferred pixel data is displayed on the LCD 104a in the example of operation flow described in the fifth embodiment, the information does not necessarily have to be displayed on the LCD 104a. Even without displaying the information, the user can input a request for retransmitting untransferred pixel data through the operation panel. In this case, upon a user's request for retransmission, all the sets of untransferred pixel data are transferred set by set to the corresponding destination terminals that failed to receive the data in the previous session.

<Sixth Embodiment>

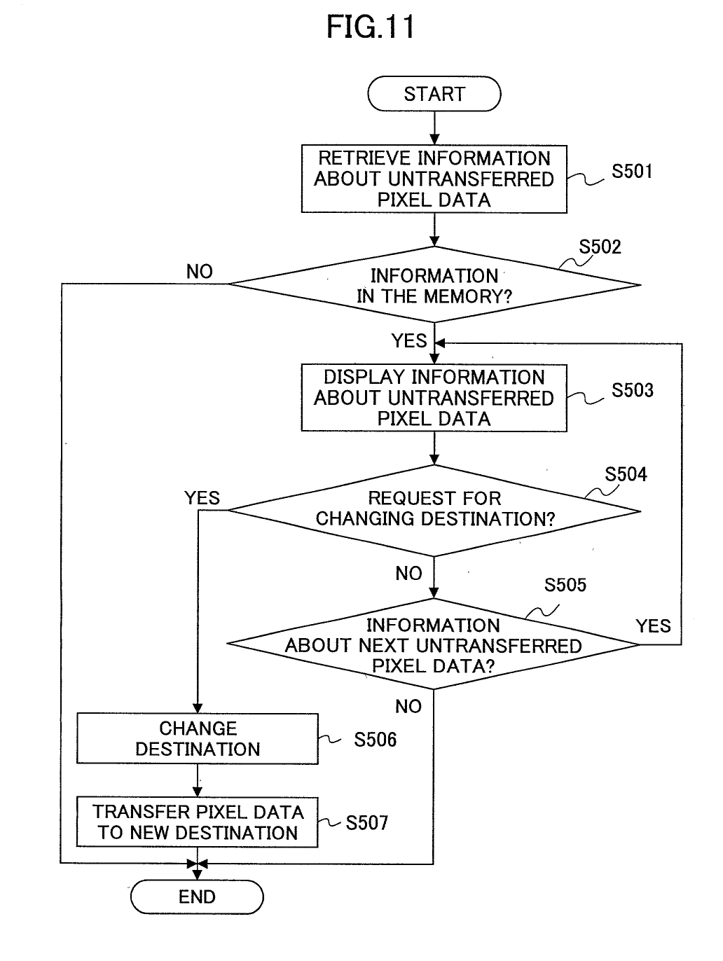

FIG. 11 illustrates an operation flow of the data communications apparatus 100 to allow the user to change the destination according to the sixth embodiment of the invention.

As in the previous embodiments, the user can have the information about untransferred pixel data displayed on the LCD 104a through manipulation of the operation panel 104. Upon detecting the user's manipulation, the system controller 105 retrieves from the system memory 103 information about untransferred pixel data (in step S501), and determines whether information about untransferred pixel data exists in the system memory 103 (in step S502).

If there is no information about untransferred pixel data (NO in S502), the process terminates. If there is information about untransferred pixel data detected in the system memory 103 (YES in S502), the system controller 105 causes the information to be displayed on the LCD 104a (in step S503).

Based on the information displayed on the LCD 104a, the user can determines if the destination should be changed. If the destination of the untransferred pixel data needs to be changed, the user inputs a request for changing the destination for the current set of pixel data through the operation panel 104. In step S504, the system controller 105 determines whether there is a request for changing the destination. If there is no request for changing the destination as to the current set of untransferred pixel data (NO in S504), the system controller 105 further determines whether there is information about another set of untransferred pixel data (in step S505).

If there is no more information about untransferred pixel data sets (NO in S505), the process terminates. If there is information about another untransferred pixel data set (YES in S505), the process returns to step S503 to repeat steps S503 through S505.

If in step S504 there is a request for changing the destination input by the user, the system controller 105 changes the destination for the current set of untransferred pixel data (in step S506), and transfers this pixel data to the newly selected destination (in step S507). Then, the process terminates.

For example, there are two unsuccessful destinations, namely facsimile #03-XXXX-XXXX and e-mail address ΔΔΔΔ@ricoh.co.jp, for the current set of untransferred pixel data. Then, the user may delete one of the unsuccessful destinations (e.g., the facsimile #03-XXXX-XXXX) for a later session. Alternatively, the user may add a new destination of facsimile #045-YYY-YYYY for the current set of untransferred pixel data source information, other than facsimile #03-XXXX-XXXX and e-mail address ΔΔΔΔ@ricoh.co.jp. Furthermore, the user can change unsuccessful e-mail address ΔΔΔΔ@ricoh.co.jp to another e-mail address XXX@ricoh.co.jp, while facsimile #03-XXXX-XXXX is maintained for the later sessions

When transmitting the untransferred pixel data in step S507 after the destination is changed, the data communications apparatus 100 may be designed so as to transmit the pixel data only to the newly designated destination, or alternatively, to transmit the pixel data to all the unsuccessful destinations, including the newly designated one. The number of retransmissions after the change of destination may be once, or alternatively, the data communications apparatus 100 may be designed so as to repeat a limited number of sessions for data transfer until the pixel data are successfully transferred to the newly designated destination(s).

This arrangement allows the user to take urgent countermeasures because the user can manually change the destination. For example, if the destination designated by the source terminal is a server, and if the pixel data are not successfully transferred to the designated server, then, the destination can be changed to another server so as to transfer the pixel data without much delay.

In step 507, the pixel data retained in the memory 102 are transmitted automatically to the newly designated destination(s) immediately after the change of destination; however, the data communications apparatus 100 may be designed so as to transmit the pixel data to the newly designated destination only when the user inputs a data transfer command.

<Seventh Embodiment>

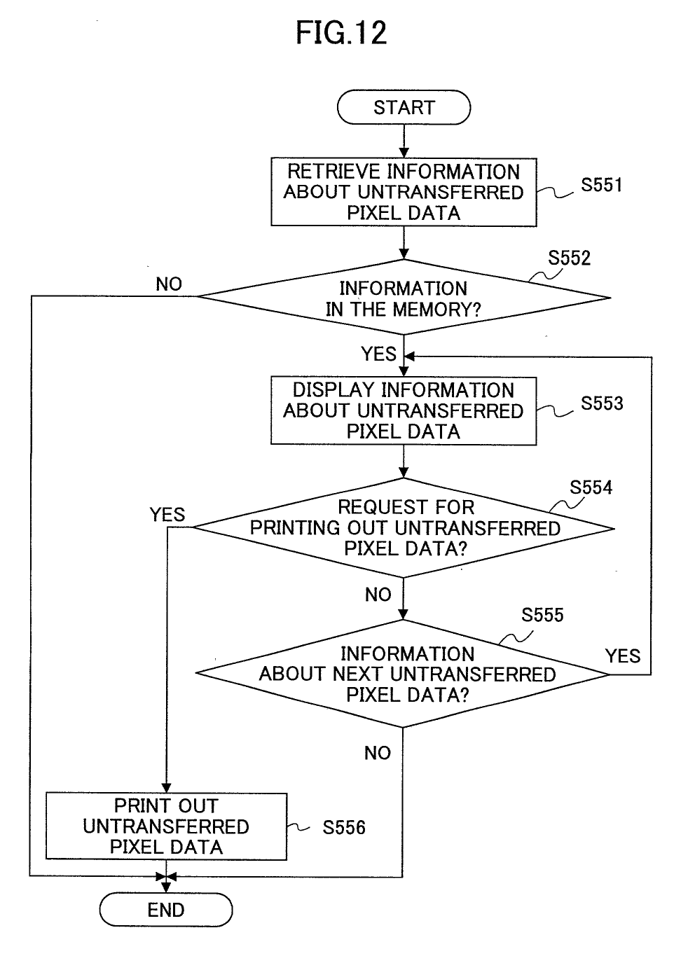

FIG. 12 illustrates an operation flow of the data communications apparatus 100 to allow the user to manually print out the untransferred pixel data according to the seventh embodiment.

As in the previous embodiments, the user can have the information about untransferred pixel data displayed on the LCD 104a through manipulation of the operation panel 104. Upon detecting the user's manipulation, the system controller 105 retrieves from the system memory 103 information about untransferred pixel data (in step S551), and determines whether information about untransferred pixel data exists in the system memory 103 (in step S552).

If there is no information about untransferred pixel data (NO in S552), the process terminates. If there is information about untransferred pixel data detected in the system memory 103 (YES in S552), the system controller 105 causes the information to be displayed on the LCD 104a (in step S553).

Based on the information displayed on the LCD 104a, the user can determine whether the untransferred pixel data should be output as hard copy. If printed-out hard copy is required, the user can input a print command through the operation panel 104. The system controller 105 monitors the input signal and determines whether there is a print command input by the user (in step S554). If there is no print command detected in step S554, then the system controller 105 further determines whether there is information about another set of untransferred pixel data (in step S555).

If there is no more information about untransferred pixel data (NO in step S555), the process terminates. If there is information about another set of untransferred pixel data (YES in step S555), the process returns to step S553 to repeat steps S553 through S555.

If in step S554 there is a print command detected, the system controller 105 causes the recording/printing unit 109 to print out the untransferred pixel data corresponding to the information displayed on the LCD 104a (in step S556).

To be more precise, upon detecting the user's print command, the system controller 105 reads the pixel data corresponding to the information displayed on the LCD 104a out of the pixel data memory 102, and causes the DCR 101 to reconstruct the compressed data. Then the system controller 105 supplies the reconstructed data to the line buffer 106 for each data line, which is then transferred to the recording/printing unit 109. The recording/printing unit 109 prints out the reconstructed pixel data on a recording medium supplied from the paper feeder 110.

The data communications apparatus 100 of the seventh embodiment allows the user to manually print out untransferred pixel data depending on, for example, importance of the pixel data. The user can confirm the contents of the pixel data before the pixel data are deleted from the pixel data memory 102.

<Eighth Embodiment>

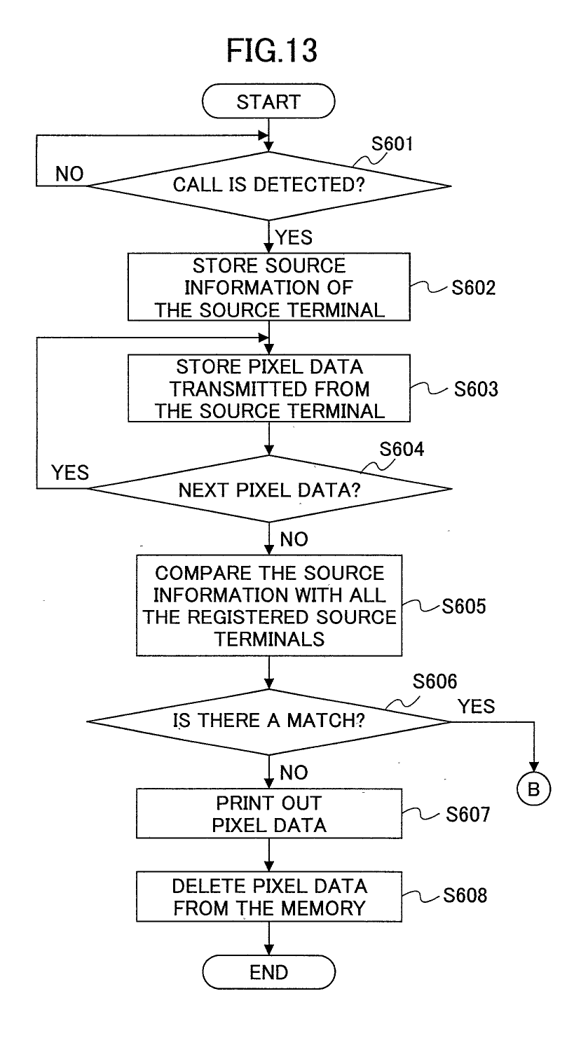

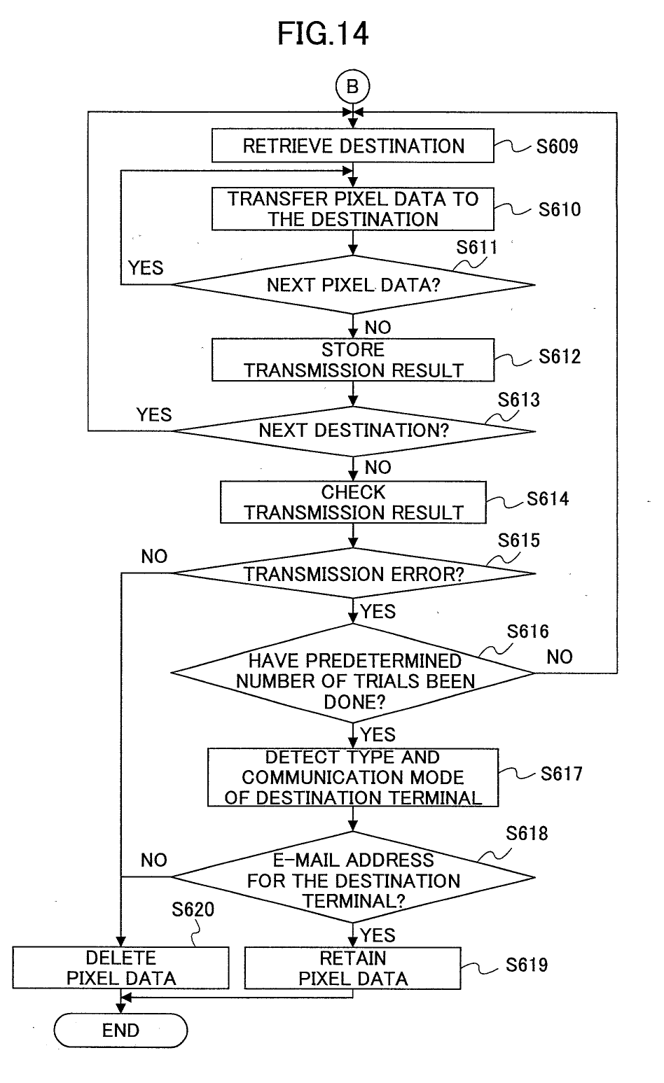

FIG. 13 and FIG. 14 illustrate an operation flow of the data communications apparatus 100 to retain or delete untransferred pixel data depending on the communication mode of the destination according to the eighth embodiment of the invention. The process shown in FIG. 14 continues from point B shown in FIG. 13.

Since the first half of the operation flow shown in FIG. 13 is similar to that shown in FIG. 4 and the latter half of the operation flow shown in FIG. 14 is similar to that of FIG. 5, the overlapping explanation will be omitted.

If a transmission error is found in the transmission result of the current session and if a predetermined number of retransmission has already been tried (YES in steps S615 and S616), the system controller 105 checks the types and the communication modes of the destination terminals to which the pixel data have not been successfully transferred (in step S617). The system controller 105 determines whether any of the unsuccessful destination terminals have e-mail addresses (in step S618).

If there are any destination terminals having e-mail addresses contained in the unsuccessful destinations (YES in S618), the system controller 105 causes the pixel data to be retained in the pixel data memory (in step S619).

If there is no e-mail address contained in the unsuccessful destinations (NO in S618), the system controller 105 deletes the pixel data and the source information from the pixel data memory 102 and system memory 103, respectively (in step S620).

In this manner, the system controller 105 determines whether the pixel data should still be retained in the pixel data memory 102 based on the type and the communication mode of the destination terminal. If the unsuccessful destination terminal is a machine that exclusively executes facsimile (such as G3-FAX or G4-FAX), the pixel data are not retained any longer. In this case, the untransferred pixel data are printed out to inform the user of the failure of facsimile transfer. If the unsuccessful destination terminal executes electronic mail (e.g., a server or a personal computer), then the untransferred pixel data are retained in the memory for further sessions.

As has been described above, the operability of the data communications apparatus is improved as compared with the conventional data communications apparatuses, especially when a predetermined number of initial attempts at data transfer are unsuccessful.

Although the invention has been described using specific examples, the present invention is not limited to those examples, but includes many substitutions and modifications without departing from the scope of the invention.

This patent application is based on and claims the benefit of the earlier filing date of Japanese patent application No. 2001-188443 filed Jun. 21, 2001, the entire contents of which are hereby incorporated by reference.

What is claimed is:

1. A data communications apparatus comprising:
a memory;
a data transfer unit configured to receive data from a source terminal, store the received data in the memory, and transfer the stored data to a destination terminal; and
a determination unit configured to determine whether the data transfer to the destination terminal has been successfully carried out, the memory retaining the data for a predetermined retention time if the data transfer has been unsuccessful.

2. The data communications apparatus according to claim 1, wherein the data transfer unit further tries to retransmit the data up to a predetermined number of times if the data transfer has been unsuccessful, and wherein the memory retains the data for the predetermined retention time if the predetermined number of retransmissions is unsuccessful.

3. The data communications apparatus according to claim 2, wherein the data transfer unit automatically sets up the retention time when the predetermined number of retransmissions is unsuccessful.

4. The data communications apparatus according to claim 1, further comprising an operation panel configured to allow a user to set the retention time.

5. The data communications apparatus according to claim 2, further comprising an operation panel configured to allow a user to set the retention time.

6. The data communications apparatus according to claim 2 wherein the data retained in the memory is automatically deleted after the retention time has passed.

7. The data communications apparatus according to claim 2, further comprising:
a display configured to display information about the data retained in the memory; and
an operation panel configured to allow a user to input a data deletion command based on the information on the display, wherein the data retained in the memory is deleted in response to the data deletion command.

8. The data communications apparatus according to claim 2, wherein the data transfer unit further retransmits the data at least once within the retention time if the predetermined number of retransmissions is unsuccessful.

9. The data communications apparatus according to claim 1, further comprising:
a display configured to display information about the data retained in the memory; and
an operation panel configured to allow a user to input a retransmission command based on the information on the display, wherein the data transfer unit retransmits the data in response to the retransmission command.

10. The data communications apparatus according to claim 2, further comprising:
a display configured to display information about the data retained in the memory; and
an operation panel configured to allow a user to input a retransmission command based on the information on the display, wherein the data transfer unit further retransmits the data in response to the retransmission command after the predetermined number of unsuccessful retransmissions.

11. The data communication apparatus according to claim 1, further comprising:
a display configured to display information about the data retained in the memory; and
an operation panel configured to allow a user to change the destination terminal to another destination, wherein the data transfer unit retransmits the data to said other destination.

12. The data communication apparatus according to claim 2, further comprising:
a display configured to display information about the data retained in the memory; and
an operation panel configured to allow a user to change the destination terminal to another destination, wherein the data transfer unit retransmits the data to said other destination.

13. The data communication apparatus according to claim 1, further comprising:
a printing unit;
a display configured to display information about the data retained in the memory; and
an operation panel configured to allow a user to input a print command based on the information on the display, wherein the printing unit prints the data in response to the print command.

14. The data communication apparatus according to claim 2, further comprising:
a printing unit;
a display configured to display information about the data retained in the memory; and
an operation panel configured to allow a user to input a print command based on the information on the display, wherein the printing unit prints the data in response to the print command.

15. The data communication apparatus according to claim 1, wherein the determination unit determines whether the data are to be retained in the memory based on a type and a communication mode of the destination terminal.

16. The data communication apparatus according to claim 2, wherein the determination unit determines whether the data are to be retained in the memory after the predetermined number of unsuccessful retransmissions based on a type and a communication mode of the destination terminal.

17. The data communication apparatus according to claim 15, wherein the memory retains the data if the destination terminal has an electronic mailing function.

18. The data communication apparatus according to claim 16, wherein the memory retains the data after the predetermined number of unsuccessful retransmissions if the destination terminal has an electronic mailing function.
